(19) United States
(12) Patent Application Publication
(10) Pub. No.: US 2013/0221138 A1
(43) Pub. Date: Aug. 29, 2013

(54) Fuel injector

(71) Applicant: Philipp ROGLER, Stuttgart (DE)

(72) Inventor: Philipp ROGLER, Stuttgart (DE)

(73) Assignee: Robert Bosch GmbH, Stuttgart (DE)

(21) Appl. No.: 13/780,665

(22) Filed: Feb. 28, 2013

(30) Foreign Application Priority Data
Feb. 29, 2012 (DE) 102012203124.3

(51) Int. Cl. F02M 51/06

(52) U.S. Cl. CPC F02M 51/06
USPC 239/585.5

(57) ABSTRACT

A fuel injector, in particular for injecting fuel into an internal combustion engine, including a housing having at least one injection opening, an internal pole, which is stationary in relation to the housing, a magnet coil acting magnetically on the internal pole, an armature, which is linearly movable in relation to the housing, a valve needle, which is linearly movable in relation to the housing and in relation to the armature, forming a valve seat together with the housing, a first stop face, which is stationary in relation to the housing, and a second stop face, which is formed on the valve needle, the second stop face striking the first stop face in an end position of the valve needle at the maximum valve needle lift.

### RELATED APPLICATION INFORMATION

The present application claims priority to and the benefit of German patent application no. 10 2012 203 124.3, which was filed in Germany on Feb. 29, 2012, the disclosure of which is incorporated herein by reference.

### FIELD OF THE INVENTION

The present invention relates to a fuel injector, in particular for injecting fuel into an internal combustion engine.

### BACKGROUND INFORMATION

There are fuel injectors in the related art for channel injection or direct injection of gasoline, for example, having a valve needle which is moved by an actuator (electromagnet or piezoelectric actuator) against a closing spring, in such a way that a desired quantity of fuel is introduced in a targeted manner. The armature may optionally be decoupled from the valve needle. There are also believed to be approaches in which the moving mass of the valve needle is divided into several partial masses which are coupled by springs, guides and stop faces. German patent document DE 101 08 945 A1 discusses one such configuration.

In general, the valve needle in the unenergized state is pressed by the return spring into the valve seat. In two-part configurations, the armature is pressed by another return spring either against the stop ring or against the stop sleeve. During needle opening, the armature initially strikes the stop ring, entrains the valve needle and then strikes the internal pole in the case of one-part and two-part needle configurations. If the armature strikes the internal pole, then the valve needle in a two-part needle configuration may continue the movement.

FIG. 1 shows a diagram of a fuel injector according to the related art. Time t is plotted on the horizontal axis here. An upper section 20 on the vertical axis indicates a current profile 23. A central section 21 indicates the progress of a valve needle lift 24 as a solid line. A progress of an armature lift 25 is shown with a dotted line in a lower section 22 and in central section 21. A detail 26 in central section 21 is shown. A stable state of the two-mass system is achieved only when the valve needle, which is pressed by the closing spring in the direction of the armature, is again in contact with the armature.

However, if the current opening the valve needle (see current profile 23) is shut down in such a way that the valve needle is in flight while the armature still remains at the internal pole, the result is the valve being closed from an undefined state. Detail 26 in FIG. 1 shows the ballistic trajectory of the valve needle after the armature has reached the internal pole. If the valves also vary in their needle movement from one specimen to the next, then great changes in the valve needle movement and thus in the dispensed quantity as a target variable may take place due to these differences in the so-called transition range between partial and full-lift operation.

### SUMMARY OF THE INVENTION

The fuel injector according to the present invention having the features described herein provides for limiting the maximum possible valve needle lift by a stop of the valve needle at the internal pole or on the housing. This eliminates the ballistic trajectory of the valve needle according to detail 26 in FIG. 1. The valve needle lifting movement may thus be controlled much more accurately than previously and thus the quantity of fuel to be dispensed may be predefined more accurately. According to the exemplary embodiments and/or exemplary methods of the present invention, the progress of the valve needle lift over time is defined more accurately than previously by the mechanical stops and their configuration. The exemplary embodiments and/or exemplary methods of the present invention thus are intended to improve the quantitative metering of fuel injectors.

In the case of fuel injectors, this has positive effects on the formation of the mixture in the combustion chamber and thus also on the combustion. Emissions and consumption of fuel by an internal combustion engine are thus reduced and the running smoothness is improved due to the fuel injector according to the exemplary embodiments and/or exemplary methods of the present invention. All these advantages are achieved by a fuel injector, in particular for injecting fuel into an internal combustion engine, including a housing having at least one injection opening and an internal pole in a stationary mount opposite the housing. Furthermore, the fuel injector includes a magnet coil acting magnetically on the internal pole and an armature that is linearly movable in relation to the housing. Furthermore, the fuel injector includes a valve needle which is linearly movable in relation to the housing and in relation to the armature and which forms a valve seat together with the at least one injection opening.

A first stop face in a stationary mount on the housing and a second stop face formed on the valve needle are provided in the fuel injector. In one end position of the valve needle, the second stop face strikes the first stop face. In this end position, the valve needle has the maximum valve needle lift, so that the maximum quantity of fuel may be passed through the injection opening in this position. According to the exemplary embodiments and/or exemplary methods of the present invention, the maximum possible valve needle lift is limited by the first and second stop faces. In an embodiment, the armature does not come into contact with the internal pole in any position. According to the exemplary embodiments and/or exemplary methods of the present invention, this is a two-mass system since the valve needle and the armature are situated in such a way that they are separately movable linearly in relation to the housing.

The further descriptions herein define refinements of the exemplary embodiments and/or exemplary methods of the present invention.

In one embodiment, it is provided that the first stop face is formed on the internal pole. Alternatively, it is also possible to form the first stop face on the housing itself or on another component which is in a stationary mount on the housing.

In addition, it may be provided that the internal pole includes a stop bush, the first stop face being formed on this stop bush. The stop bush may be made of a hard or hardenable or hardened or hard-coated material to increase its service life and thus results in an inexpensive and durable stop. A chromium layer on the internal pole, which has been used previously, may thus be dispensed with.

In addition, a first return spring may be provided between the internal pole and the valve needle. This first return spring loads the valve needle in the direction of the valve seat, so that the valve seat is closed in the unenergized state of the magnet coil.

In addition, a third stop face, which faces the valve seat, may be formed on the valve needle, and a fourth stop face, which faces away from the valve seat, is formed on the armature. The third stop face and the fourth stop face strike one another during the movement of the valve needle. When the valve seat is opened, the armature is moved via the magnetized internal pole. The fourth stop face then strikes the third stop face and thus the armature entrains the valve needle. This movement is stopped by the strike of the first and second stop faces between the valve needle and the internal pole or the housing.

In addition, a second return spring may be provided for returning the armature. The second return spring may load the armature in the direction of the valve seat. For this purpose, a spring cup may be mounted on the armature. One end of the second return spring is supported on the spring cup and the other end of the second return spring is supported on the valve needle, on a component in a fixed mount on the valve needle or on a component in a fixed mount on the housing.

Furthermore, a fifth stop face, which faces the valve seat, may be formed on the armature, and a sixth stop face, which faces away from the valve seat, is formed on the valve needle. The fifth stop face and the sixth stop face strike one another during the movement of the valve needle. The armature may include a stop bush. The fourth and fifth stop faces are formed on this stop bush. The customary chromium layer on the top side of the armature and optionally on the bottom side may thus be omitted in particular if the additional stop bush is made of a hard or hardenable or hardened or hard-coated material. The additional stop bush may be made of an austenitic material, so that the magnetic force may be increased because leakage fluxes to the valve needle are minimized.

The valve needle may include a stop ring situated between the internal pole and the armature. The second stop face may be formed on a side of the stop ring facing away from the valve seat. In addition, the first return spring may also be supported on this side of the stop ring. The third stop face may be formed on the side of the stop ring, which faces a valve seat.

In addition, the valve needle may include a stop sleeve on the side of the armature facing the valve seat. The sixth stop face is formed on this stop sleeve. In addition, the second return spring may be supported on a side of the stop sleeve facing the valve seat.

A recess for the stop ring is advantageously provided on the internal pole and/or on the armature. If such a recess is provided, then the first stop face may be situated in the recess in the internal pole. The fourth stop face may be formed in the recess in the armature. In addition, a face of the recess in the internal pole may function as a linear guidance for the stop ring and thus for the linear guidance of the valve needle. In addition, one face of the recess in the armature may be used to guide the armature in relation to the stop ring and thus in relation to the valve needle.

It may be provided that the armature is guided linearly on the valve needle and/or on the housing.

In one variant, the valve needle includes, in particular, a spherical valve closing body. This valve closing body is fixedly connected to the valve needle. In the closed state of the valve seat, the valve closing body is pressed onto the housing, thereby preventing outflow of fuel through the at least one injection opening. With appropriate energization of the coil, the valve closing body lifts off from the housing and enables the flow of fuel of the at least one injection opening. The fuel is thereby guided through the valve needle, which is hollow on the inside. As an alternative to this, it is also possible to configure the valve needle in a solid form. The flow is then guided through the stop ring and/or the internal pole and the armature and/or an interspace between the armature and the housing and/or the valve needle. However, this does not alter the functionality of the stops at all.

The stop between the first and the second stop faces is usually placed as far inward as possible so as to interfere as little as possible with the magnetic field. Furthermore, it should be noted that the air gap between the armature and the internal pole is minimized in the opened state, so that the magnetic force is maximized and the required energy demand is minimized. This requires high precision during the production of the individual parts and during the assembly. The gap and the volume between the parts moving in relation to one another may be utilized to adjust a desired opening and closing dynamics of the fuel injector.

Exemplary embodiments of the present invention are described in greater detail below with reference to the accompanying drawings.

### BRIEF DESCRIPTION OF THE DRAWINGS

FIG. 1 shows a diagram of a fuel injector according to the related art.

FIG. 2 shows a fuel injector according to the present invention according to a first exemplary embodiment.

FIG. 3 shows a diagram of a fuel injector according to the present invention according to all exemplary embodiments.

FIG. 4 shows a fuel injector according to the present invention according to a second exemplary embodiment.

FIG. 5 shows a fuel injector according to the present invention according to a third exemplary embodiment.

FIG. 6 shows a fuel injector according to the present invention according to a fourth exemplary embodiment.

FIG. 7 shows a fuel injector according to the present invention according to a fifth exemplary embodiment.

FIG. 8 shows a fuel injector according to the present invention according to a sixth exemplary embodiment.

FIG. 9 shows a fuel injector according to the present invention according to a seventh exemplary embodiment.

### DETAILED DESCRIPTION

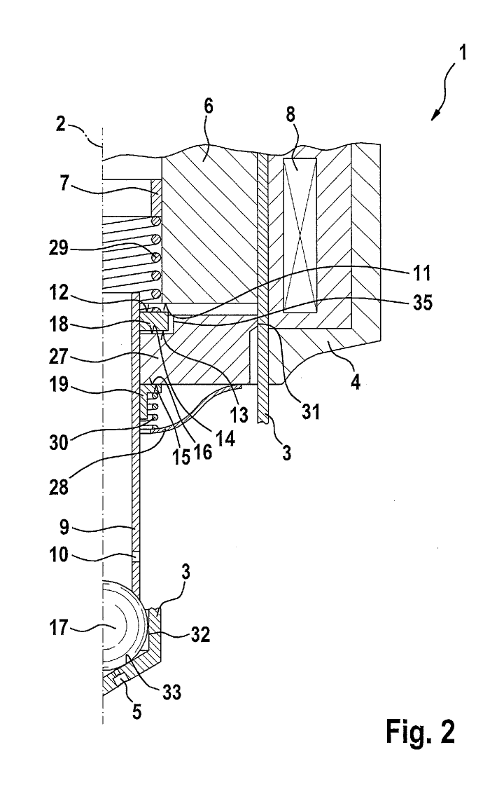

Seven exemplary embodiments of a fuel injector 1 are shown with reference to FIGS. 2 through 9. The fuel injector is always shown in half section. The same parts and those having the same function are labeled with the same reference numerals in all exemplary embodiments.

FIG. 2 shows a fuel injector 1 according to the first exemplary embodiment. This shows the half section up to a central axis 2 of fuel injector 1. Fuel injector 1 includes a housing 3 having a magnetic cup 4 and at least one injection opening 5. An internal pole 6 is mounted in housing 3. Internal pole 6 is in a stationary position in relation to housing 3. Internal pole 6 is ring-shaped. An adjusting sleeve 7 is attached to its inside.

A magnet coil 8 is situated at the height of internal pole 6 in magnetic cup 4 of housing 3.

A valve needle 9 is guided linearly movably in housing 3 along central axis 2. Valve needle 9 includes a spherical valve closing body 17. This valve closing body 17 together with housing 3 forms a valve seat 33. In addition, valve needle 9 is at least partially hollow on the inside. The side wall of valve needle 9 is perforated by at least one flow-through opening 10. In addition, valve needle 9 includes a stop ring 18 and a stop sleeve 19.

Furthermore, fuel injector 1 has an armature 27. Armature 27 is movable linearly along central axis 2 in relation to valve needle 9 and housing 3. Armature 27 includes a spring cup 28.

A first return spring 29 is situated between adjusting sleeve 7 and stop ring 18. A second return spring 30 is situated between spring cup 28 and stop sleeve 19. First return spring 29 and second return spring 30 are configured as compression springs.

An upper guide 31 is formed between armature 27 and housing 3. Valve needle 9 here is guided linearly in relation to armature 27, so that upper guide 31 is used to guide armature 27 and also valve needle 9. A lower guide 23 is formed in the lower area of housing 2 to guide valve closing body 17.

A first recess 35 is provided on the side of armature 27 facing internal pole 6. First recess 35 is dimensioned according to stop ring 18, so that the stop ring is accommodated at least partially in first recess 35.

In the unenergized state of coil 8, first return spring 29 loads valve needle 9 in the direction of valve seat 33, thus causing valve seat 33 to close. At the same time, second return spring 30 loads spring cup 28 and thus armature 27 in the direction of stop sleeve 19. On energization of coil 8, internal pole 6 is magnetized and thus attracts armature 27. Armature 27 entrains valve needle 9 via stop ring 18. Valve closing body 17 may lift off from injection opening 5. The fuel flows here through valve needle 9, which is hollow on the inside, and through flow-through opening 10 to injection opening 5 and then through injection opening 5 into the combustion chamber of an internal combustion engine.

A first stop face 11 is defined on a side of internal pole 6 facing valve seat 33. First stop face 11 is opposite a second stop face 12 on stop ring 18. A third stop face 13 is defined on the side of stop ring 18 facing valve seat 33. A fourth stop face 14 is opposite third stop face 13 on armature 27. A fifth stop face 15 is formed on the side of armature 27 facing valve seat 33. A sixth stop face 16 on stop sleeve 19 is opposite fifth stop face 15.

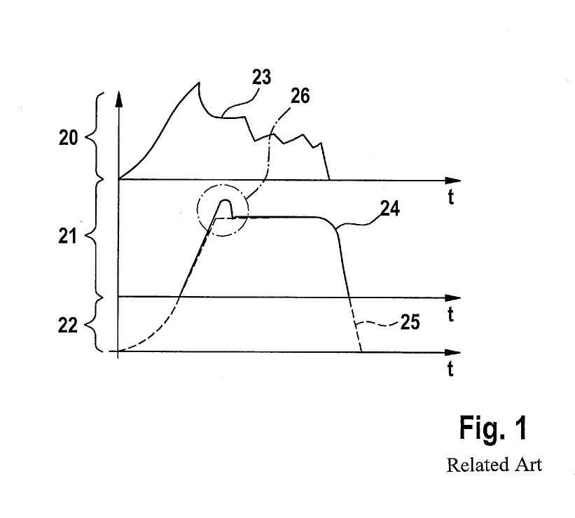

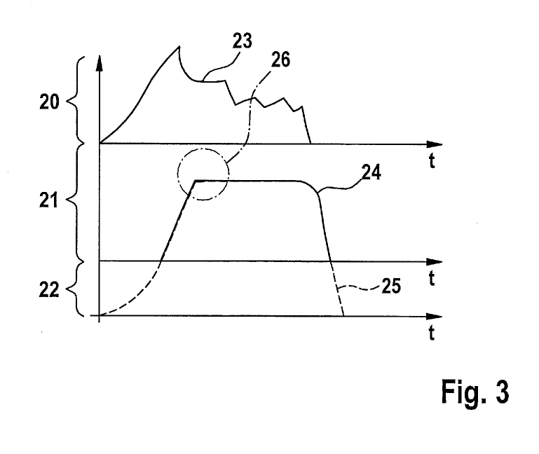

FIG. 3 shows a diagram of fuel injector 1 according to all the exemplary embodiments. Similarly to FIG. 1, current profile 23 on coil 8 is shown here in upper section 20. Middle section 21 shows the progress of valve needle lift 24 as a solid line. Bottom section 22 and middle section 21 show the progress of armature lift 25 as a dashed line. Detail 26 shows that the ballistic trajectory of valve needle 9 after armature 27 has reached its position as close as possible to internal pole 6 is omitted in comparison with FIG. 1. The lifting motion of the valve needle is controllable very precisely due to the strike between first and second stop faces 11, 12, and therefore the quantity of fuel to be dispensed may also be predefined very accurately.

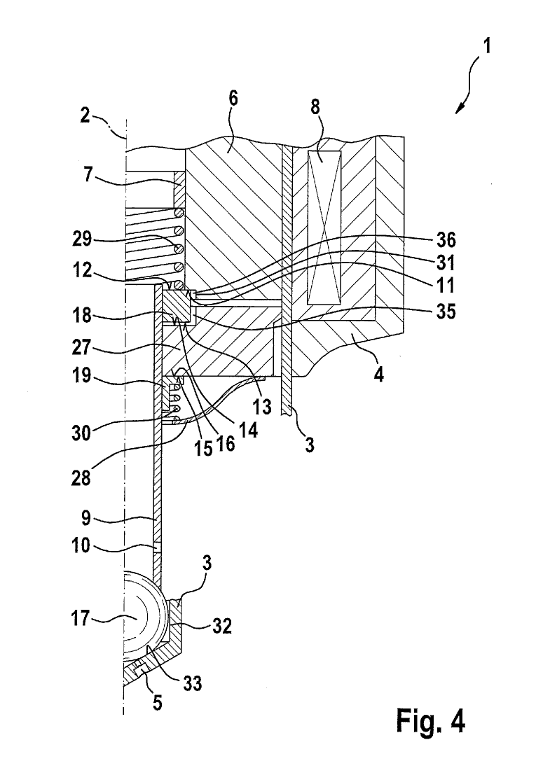

FIG. 4 shows fuel injector 1 according to a second exemplary embodiment. In contrast with the first exemplary embodiment, in the second exemplary embodiment a second recess 36 for stop ring 18 is formed in internal pole 6. Accordingly, first stop face 11 is also formed in this second recess 36. Upper guide 31 is formed between a face of second recess 36 parallel to central axis 2 and stop ring 18. In this exemplary embodiment, armature 27 is guided on valve needle 9. Valve needle 9 is guided in second recess 36 of internal pole 6 via stop ring 18.

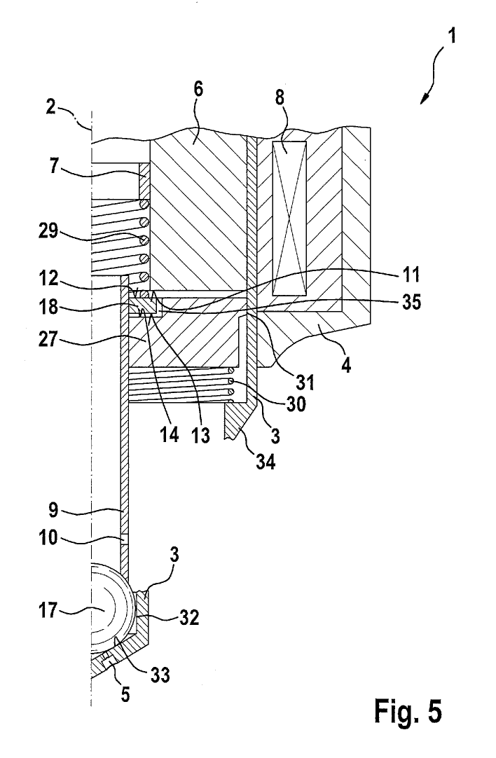

FIG. 5 shows fuel injector 1 according to a third exemplary embodiment. In the third exemplary embodiment, second return spring 30 is supported at one end against armature 27 and at the other end against a spring stop 34 in a fixed housing mount. Upper guide 31 here is formed between armature 27 and housing 3.

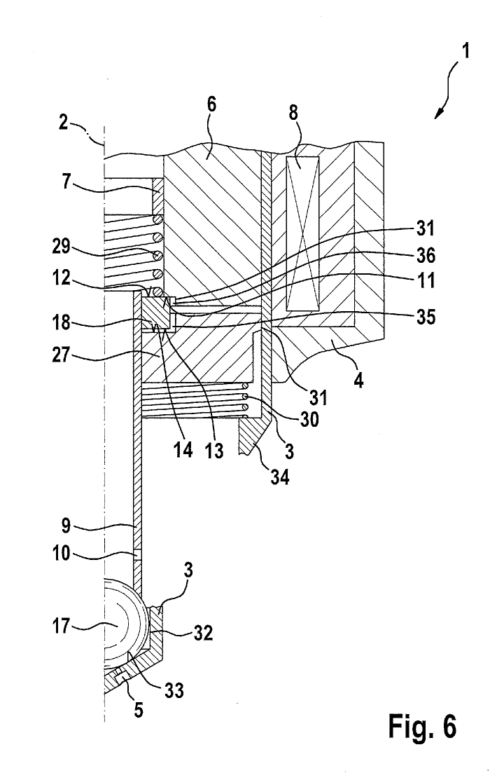

FIG. 6 shows fuel injector 1 according to a fourth exemplary embodiment. Just as in the third exemplary embodiment, here again second return spring 30 is supported in relation to spring stop 34 in a fixed housing mount. However, second recess 36 is situated here in internal pole 6 as in the second exemplary embodiment, for example. Valve needle 8 is guided here via upper guide 31 within second recess 36.

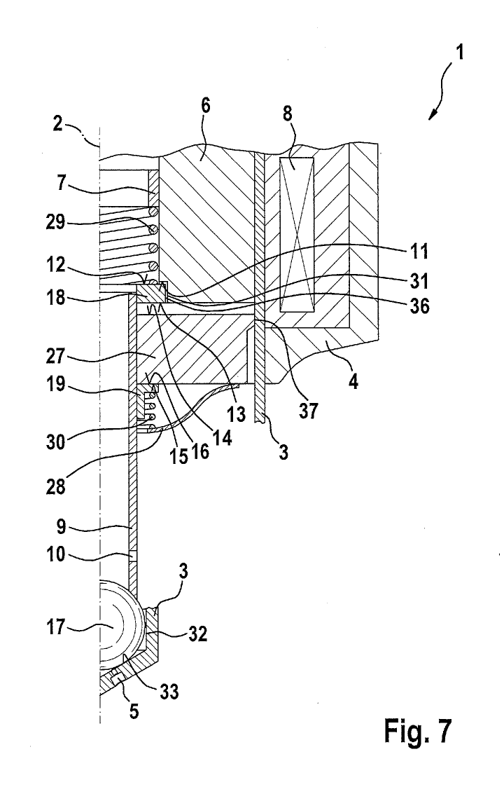

FIG. 7 shows fuel injector 1 according to a fifth exemplary embodiment. Second return spring 30 is supported here at one end against stop sleeve 19 and at the other end against spring cup 28 as in the first and second exemplary embodiments. First recess 35 is omitted in the fifth exemplary embodiment. Upper guide 31 between stop ring 18 and internal pole 6 is formed in second recess 36. Alternatively or additionally, another guide 37 may be formed between armature 27 and housing 3 to guide armature 27.

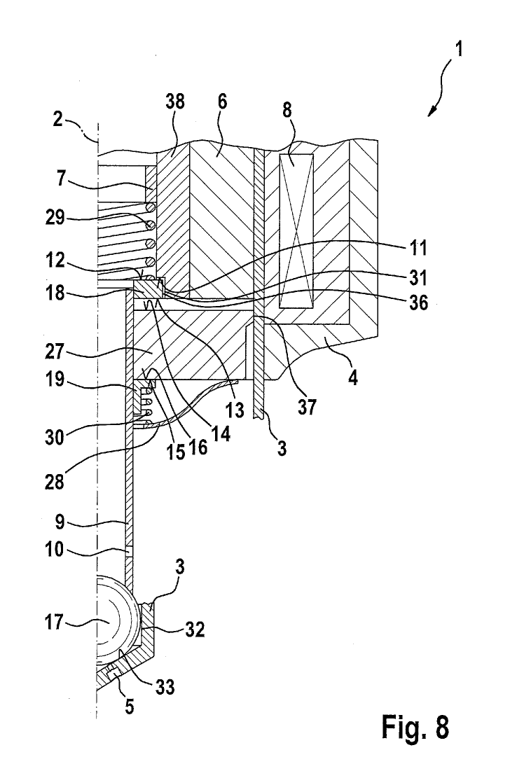

FIG. 8 shows fuel injector 1 according to a sixth exemplary embodiment. The sixth exemplary embodiment corresponds to the fifth exemplary embodiment except for an additional stop bush 38. Stop bush 38 is situated in a fixed housing mount. Adjusting sleeve 7 as the spring support for first return spring 29 is attached to first stop bush 38. In addition, first stop face 11 and second recess 36 are situated on first stop bush 38.

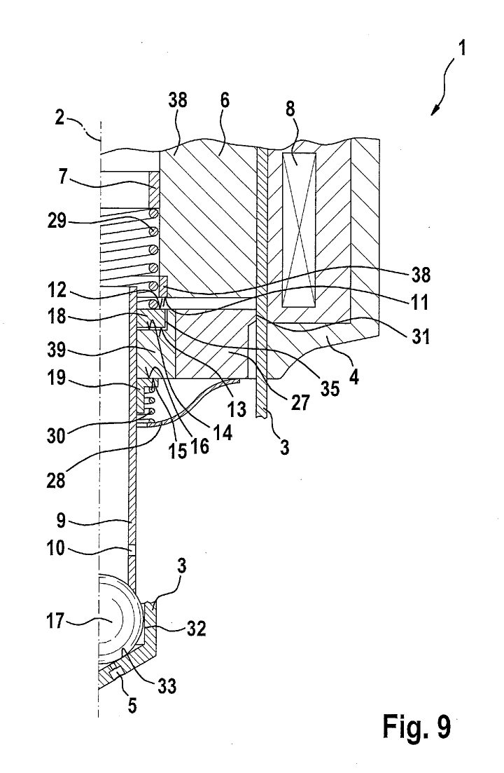

FIG. 9 shows fuel injector 1 according to a seventh exemplary embodiment. First stop bush 38 here is configured without second recess 36. Armature 27 includes a second stop bush 39. First recess 35 and fourth stop face 14 are formed on one side of second stop bush 39. Upper guide 31 is formed between armature 27 and housing 3.

What is claimed is:

1. A fuel injector for injecting fuel into an internal combustion engine, comprising:
a housing having at least one injection opening;
an internal pole, which is stationary in relation to the housing;
a magnet coil to act magnetically on the internal pole;
an armature, which is linearly movable in relation to the housing;
a valve needle, which is linearly movable in relation to the housing and in relation to the armature and together with the housing forms a valve seat;
a first stop face, which is stationary in relation to the housing; and
a second stop face, which is formed on the valve needle, the second stop face striking the first stop face in an end position of the valve needle at the maximum valve needle lift.

2. The fuel injector of claim 1, wherein the first stop face is formed on the internal pole.

3. The fuel injector of claim 2, wherein the internal pole includes a stop bush on which the first stop face is formed.

4. The fuel injector of claim 1, wherein there is a first return spring between the internal pole and the valve needle.

5. The fuel injector of claim 1, wherein a third stop face which faces the valve seat is formed on the valve needle, and a fourth stop face which faces away from the valve seat is formed on the armature, the third stop face and the fourth stop face striking one another during the movement of the valve needle.

6. The fuel injector of claim 1, wherein there is a second return spring between the armature and the valve needle or between the armature and the housing.

7. The fuel injector of claim 1, wherein a fifth stop face facing the valve seat is formed on the armature and a sixth stop face facing away from the valve seat is formed on the valve needle, the fifth stop face and the sixth stop face striking one another during the movement of the valve needle.

8. The fuel injector of claim 1, wherein the valve needle includes a stop ring between the internal pole and the armature.

9. The fuel injector of claim 8, wherein at least one of the internal pole and the armature enclose a recess for accommodating the stop ring.

10. The fuel injector of claim 1, wherein the armature is linearly guided at least one of on the valve needle and on the housing.
